(19) United States
(12) Patent Application Publication
(10) Pub. No.: US 2007/0160844 A1
(43) Pub. Date: Jul. 12, 2007

(54) Coated inserts

(75) Inventor: Ingemar Hessman, Sandviken (SE)

Correspondence Address: DRINKER BIDDLE & REATH (DC), 1500 K STREET, N.W., SUITE 1100, WASHINGTON, DC, 20005-1209, US

(73) Assignee: SANDVIK INTELLECTUAL PROPERTY AB

(21) Appl. No.: 11/640,493

(22) Filed: Dec. 18, 2006

(30) Foreign Application Priority Data
Dec. 30, 2005 (SE) 0502959-0

(51) Int. Cl. B32B 9/00

(52) U.S. Cl. 428/408

(57) ABSTRACT

The present invention discloses a cutting tool insert particularly for deep hole drilling comprising a cemented carbide body and a coating. The cemented carbide body is WC, from about 8 to about 11 wt-% Co and from about 0.1 to about 0.5 wt-% Cr with an HcJ-value of from about 18 to about 22 kA/m and with a CW-value of from about 0.78 to about 0.90. The coating comprises
a first, innermost layer of TiCₓN_{y}O_{z} with equiaxed grains with size and a total thickness of from about 0.1 to about 1.5 μm,
a layer of TiCₓN_{y} with a thickness of from about 2 to about 3 μm with columnar grains,
a layer of a smooth, fine-grained κ-Al₂O₃ with a thickness of from about 1 to about 2.5 μm and an outer layer of TiN with a thickness of from about 0.5 to about 1.0 μm, where the outermost layer of TiN is missing along the cutting edge.

### BACKGROUND OF THE INVENTION

The present invention relates to coated cemented carbide cutting tool inserts particularly useful for deep hole drilling with tools based on the Ejector® system.

Drilling in metals is generally divided in two types: deep hole drilling and short hole drilling. Short hole drilling means generally drilling to a depth of up to 3-5 times the drill diameter.

With short hole drilling the demands are not as great and therefore simple helix drills either of solid cemented carbide or as solid tool steel or of tool steel equipped with cemented carbide inserts are used.

Deep hole drilling however puts large demands on good chipbreaking, lubrication, cooling and chip transport. These requirements are achieved through specially developed drilling systems with specially designed drill heads connected to a drill rod which fulfills the above mentioned requirements. The drilling head may be of solid cemented carbide but is generally of tool steel or cast steel, provided with a number of inserts of cemented carbide placed in such away that they together form the desired cutting edge.

U.S. Pat. No. 5,945,207 discloses a coated cutting insert particularly useful for cutting in cast iron materials. The insert is characterized by a straight WC-Co cemented carbide body having a highly W-alloyed Co binder phase, a well-defined surface content of Co and a coating including an innermost layer of TiCₓN_{y}O_{z} with columnar grains, a layer of a fine-grained, textured Al₂O₃ and a top layer of TiCₓN_{y}O_{z} that has been removed along the cutting edge line.

U.S. Pat. No. 6,638,609 discloses coated milling inserts particularly useful for milling of grey cast iron with or without cast skin under wet conditions at low and moderate cutting speeds and milling of nodular cast iron and compacted graphite iron with or without cast skin under wet conditions at moderate cutting speeds. The inserts are characterised by a WC-Co cemented carbide with a low content of cubic carbides and a highly W-alloyed binder phase and a coating including an inner layer of TiCₓN_{y} with columnar grains followed by a layer of κ-Al₂O₃ and a top layer of TiN.

### OBJECTS AND SUMMARY OF THE INVENTION

It is an object of the present invention to provide coated cemented carbide cutting tool inserts, particularly useful for deep hole drilling of drive shafts.

In one aspect of the invention, there is provided a cutting tool insert comprising a cemented carbide body and a coating, said cemented carbide body comprising WC, from about 8 to about 11 wt-% Co and from about 0.1 to about 0.5 wt-% Cr with a polarization coercivity, HcJ, of from about 18 to about 22 kA/m and a CW-value within from about 0.78 to about 0.90, said coating comprising a first, innermost layer of TiCₓN_{y}O_{z} with x+y+z=1, y>x and z is less than about 0.2, with equiaxed grains with a size less than about 0.5 μm and a total thickness of from about 0.1 to about 1.5 μm, a layer of TiCₓN_{y} with x+y=1, x more than about 0.3 and y more than about 0.3, with a thickness of from about 2 to about 3 μm with columnar grains with an average diameter of less than about 5 μm, a layer of a smooth, fine-grained, from about 0.5 to about 2 μm grain size κ-Al₂O₃ with a thickness of from about 1 to about 2.5 μm and an outermost layer of TiN with a thickness of from about 0.5 to about 1.0 μm, where the outermost layer of TiN is missing along the cutting edge.

In another aspect of the invention, there is provided a method of making a deep hole drilling cutting tool insert comprising a cemented carbide body and a coating wherein said cemented carbide body which comprises WC, from about to 8 to about 11 wt-% Co and from about 0.1 to about 0.5 wt-% Cr with a polarization coercivity, HcJ, of from about 18 to about 22 kA/m and with an CW-value within from about 0.78 to about 0.90, is coated with a coating comprising a first innermost layer of TiCₓN_{y}O_{z} with x+y+z=1, y>x and z less than about 0.2 with equiaxed grains with a size less than about 0.5 μm and a total thickness of from about 0.1 to about 1.5 μm, using known CVD-methods, a layer of TiCₓN_{y} with x+y=1, x more than about 0.3 and y more than about 0.3, with a thickness of from about 2 to about 3 μm, with columnar grains and with an average diameter of less than about 5 m, using MTCVD-technique with acetonitrile as the carbon and nitrogen source for forming the layer in the temperature range of from about 700 to about 900° C., a smooth Al₂O₃-layer consisting essentially of κ-Al₂O₃ deposited using known CVD-methods whereby the Al₂O₃ layer has a thickness of from about 1 to about 2.5 μm, and a further 0.5-1.0 μm thick layer of TiN using known CVD- or PVD-methods, where the TiN-layer is removed along the cutting edge.

In still a further aspect of the invention, there is provided a use of inserts as described above for deep hole drilling of drive shafts for heat exchangers in steel at a cutting speed of from about 80 to about 160 m/min, feed of from about 0.1 to about 0.3 mm/rev, hole diameter of from about 16 to about 65 mm and a hole length of less than about 1500 mm.

### DETAILED DESCRIPTION OF THE PREFERRED EMBODIMENTS

It has now surprisingly been found that an essentially doubled tool life can be obtained for deep hole drilling of drive shafts by using a coated cutting tool insert comprising a cemented carbide body with a relatively high W-alloyed binder phase and with a well balanced chemical composition and grain size of the WC, a columnar TiCₓN_{y}-layer, a κ-Al₂O₃-layer, a TiN-layer and optionally with smoothed cutting edges.

According to the present invention, a coated cutting tool insert is provided of a cemented carbide body with a composition of from about 8 to about 11 wt-% Co, preferably from about 9.5 to about 10.5 wt-% Co, most preferably from about 9.9 to about 10.1 wt-% Co, from about 0.1 to about 0.5 wt-% Cr, preferably from about 0.38 to about 0.40 wt-% Cr and balance WC. The cemented carbide body may also contain smaller amounts of other elements on a level corresponding to a technical impurity. The polarization coercivity, HcJ, measured according to IEC standard 60404-7, is indirectly a measure of the WC grain size and should have a value of from about 18 to about 22 kA/m, preferably from about 19 to about 21 kA/m, most preferably from about 19.8 to about 20.2 kA/m. The cobalt binder phase is alloyed with a certain amount of W and Cr giving the invented cemented carbide cutting insert its desired properties. W and Cr in the binder phase influence the magnetic properties of cobalt and can hence be related to a value CW, defined as

CW=magnetic-% Co/wt-% Co

where magnetic-% Co is the weight percentage of magnetic material in the sample and wt-% Co is the weight percentage of Co in the sample.

The CW-value is dependent on the degree of alloying of the binder phase. Lower CW-values correspond to higher W and Cr contents and CW=1 corresponds practically to an absence of W and Cr in the binder phase.

The CW-value can vary between 1 and about 0.75 dependent on the degree of alloying. Lower CW-values correspond to higher W and Cr contents and CW=1 corresponds practically to an absence of W and Cr in the binder phase.

It has now been found according to the present invention that improved cutting performance is achieved if the cemented carbide body has a CW-value of from about 0.78 to about 0.90, preferably within from about 0.80 to about 0.89, and most preferably within from about 0.83 to about 0.87. The cemented carbide may also contain small amounts, less than about 1 volume %, of η-phase (M₆C), without any detrimental effects. From the specified CW-values (less than about 1) it also follows that no free graphite is allowed in the cemented carbide body according to the present invention.

The radius of the uncoated cutting edge is from about 5 to about 30 μm, preferably about from about 10 to about 20 μm.

The coating comprises
a first (innermost) layer of TiCₓN_{y}O_{z} with x+y+z=1, y>x and z less than about 0.2, preferably y is more than about 0.8 and z=0, with equiaxed grains with size less than about 0.5 μm and a total thickness less than about 1.5 μm, preferably more than about 0.1 μm,
a layer of TiCₓN_{y} with x+y=1, x more than about 0.3 and y more than about 0.3, preferably x is equal to or more than about 0.5, with a thickness of from about 2 to about 3 μm with columnar grains and with an average diameter of less than about 5 μm, preferably from about 0.1 to about 2 μm,
a layer of a smooth, fine-grained (average grain size about from about 0.5 to about 2 μm) Al₂O₃ consisting essentially of the κ-phase. However, the layer may contain small amounts (less than about 5 vol-%) of other phases such as θ- or the α-phase as determined by XRD-measurement. The Al₂O₃-layer has a thickness of from about 1 to about 2 μm, preferably from about 1.2 to about 1.7 μm and
a further from about 0.1 to about 1.0 m thick layer of TiN. This outermost layer of TiN has a surface roughness Rmax≦0.4 μm over a length of 10 m at least on the active part of the cutting edge. The TiN-layer is preferably removed along the cutting edge and the underlying alumina layer may be partly or completely removed along the cutting edge.

The present invention also relates to a method of making a cutting tool insert particularly for deep hole drilling comprising a cemented carbide body and a coating. The cemented carbide body comprises WC, from about 8 to about 11 wt-% Co, more preferably from about 9.5 to about 10.5 wt-% Co, most preferably from about 9.9 to about 10.1 wt-% Co and from about 0.1 to about 0.5 wt-% Cr, more preferably from about 0.38 to about 0.40 wt-% Cr with an HcJ of from about 18 to about 22 kA/m, more preferably from about 19 to about 21 kA/m, most preferably from about 19.8 to about 20.2 kA/m and with a CW-value within from about 0.78 to about 0.90, preferably within from about 0.80 to about 0.89, and most preferably within from about 0.83 to about 0.87.

The uncoated cutting edge is provided with an edge radius of from about 5 to about 30 μm, preferably about from about 10 to about 20 μm.

The coating comprises:
a first (innermost) layer of TiCₓN_{y}O_{z} with x+y+z=1, y more than about x and z less than about 0.2, preferably y more than about 0.8 and z=0, with equiaxed grains with size less than about 0.5 μm and a total thickness less than about 1.5 μm, preferably more than about 0.1 μm, using known CVD-methods,
a layer of TiCₓN_{y} with x+y=1, x more than about 0.3 and y more than about 0.3, preferably x equal to or more than about 0.5, with a thickness of from about 1 to about 3 μm, preferably from about 2 to about 2.7 μm, with columnar grains and with an average diameter of less than about 5 μm, preferably from about 0.1 to about 2 μm, using preferably MTCVD-technique (using acetonitrile as the carbon and nitrogen source for forming the layer in the temperature range of from about 700 to about 900° C.). The exact conditions, however, depend to a certain extent on the design of the equipment used,
a smooth Al₂O₃-layer essentially of κ-Al₂O₃ is deposited under conditions disclosed in e.g. U.S. Pat. No. 5,674,564, the disclosure of which is herein incorporated by reference in its entirety. The Al₂O₃ layer has a thickness of from about 0.5 to about 2.5 μm, preferably from about 1 to about 2 μm and
a from about 0.5 to about 1.0 μm thick layer of TiN with a surface roughness Rmax≦0.4 μm over a length of 10 μm at least on the active part of the cutting edge.

The smooth coating surface is obtained by gently wetblasting the coating surface with fine grained (from about 400 to about 150 mesh) alumina powder or by brushing the edges with brushes based on, e.g., SiC as disclosed, e.g., in U.S. Pat. No. 5,861,210, the disclosure of which is herein incorporated by reference in its entirety. The TiN-layer is preferably removed along the cutting edge and the underlying alumina layer may be partly or completely removed along the cutting edge.

The invention also relates to the use of cutting tool inserts according to above for deep hole drilling of drive shafts in steel at a cutting speed of from about 80 to about 160 m/min, feed of from about 0.1 to about 0.3 mm/rev, hole diameter of from about 16 to about 65 mm and a hole length of less than about 1500 mm.

The invention is additionally illustrated in connection with the following examples, which are to be considered as illustrative of the present invention. It should be understood, however, that the invention is not limited to the specific details of the examples.

### EXAMPLE 1

Cemented carbide inserts with a composition of 10 wt-% Co, 0.4 wt-% Cr and balance WC, and with an HcJ value of 20.2 kA/m and an CW-value of 0.85 as measured in the FORSTER KOERZIMAT CS 1.096 from Foerster Instruments Inc were after conventional ER-treatment to an edge radius of 15 μm coated with a 0.5 μm equiaxed TiCo_{0.05}N_{0.95}-layer (with a high nitrogen content corresponding to an estimated C/N-ratio of 0.05) followed by a 2.6 μm thick TiCo._{0.54}N_{0.46}-layer, with columnar grains by using MTCVD-technique (temperature 850-885° C. and CH₃CN as the carbon/nitrogen source). In subsequent steps during the same coating cycle, a 1.3 μm thick layer of Al₂O₃ was deposited using a temperature 970° C. and a concentration of H₂S dopant of 0.4% as disclosed in U.S. Pat. No. 5,674,564. A thin (0.5 μm) layer of TiN was deposited on top according to known CVD-technique. XRD-measurement showed that the Al₂O₃-layer consisted of 100% κ-phase.

The coated inserts were brushed using a nylon straw brush containing SiC grains. Examination of the brushed inserts in a light optical microscope revealed that the outermost, thin TiN-layer and some of the Al₂O₃-layer had been brushed away along the very cutting edge, leaving there a smooth Al₂O₃-surface. Coating thickness measurements on cross sectioned, brushed inserts showed that the outermost TiN-layer and roughly half the Al₂O₃-layer had been removed along the edge line.

### EXAMPLE 2

Inserts according to the present invention were tested in deep hole drilling of shafts in Steel, Ovako 528E.

Tool: Sandvik Coromant Ejector® drill 800.20-03D

Criterion: Flank wear, surface finish.

Reference: Sandvik Coromant Ejector® drill 800.20-03D with insert 800-060308H-P-G in grade GC1025.

Cutting Data

Cutting speed: Vc=112 m/min

Feed per rev: fn=0.22 mm

Hole diameter: 25.5 mm

Length of hole: 1160 mm

Coolant: Emulsion

Tool life of reference: 15 shafts.

Tool life of invention: 35 shafts.

Average of four tests.

The tool according to the invention showed a reduction in flank wear with improved surface finish and an increase in tool life with 133%.

### EXAMPLE 3

Inserts according to the present invention were tested in deep hole drilling of shafts in Steel, Ovako 528E

Tool: Sandvik Coromant Ejector® drill 800.20-03D

Criterion: Flank wear, surface finish.

Reference: Sandvik Coromant Ejector® drill 800.20-03D with insert 800-060308H-P-G in grade GC4025

Cutting Data

Cutting speed: Vc=137 m/min

Feed per rev: fn=0.26 mm

Hole dia.: 25.5 mm

Lenth of hole: 1160 mm

Coolant: Emulsion

Tool life of reference: 13 shafts.

Tool life of invention: 35 shafts.

Average of four tests.

The tools according to the invention showed a reduction in flank wear with improved surface finish and an increase in tool life with 169%.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. A cutting tool insert comprising a cemented carbide body and a coating, said cemented carbide body comprising WC, from about 8 to about 11 wt-% Co and from about 0.1 to about 0.5 wt-% Cr with a polarization coercivity, HcJ, of from about 18 to about 22 kA/m and a CW-value within from about 0.78 to about 0.90, said coating comprising
a first, innermost layer of TiCₓN_{y}O_{z} with x+y+z=1, y>x and z is less than about 0.2, with equiaxed grains with a size less than about 0.5 μm and a total thickness of from about 0.1 to about 1.5 μm,
a layer of TiCₓN_{y} with x+y=1, x more than about 0.3 and y more than about 0.3, with a thickness of from about 2 to about 3 μm with columnar grains with an average diameter of less than about 5 μm,
a layer of a smooth, fine-grained, from about 0.5 to about 2 μm grain size κ-Al₂O₃ with a thickness of from about 1 to about 2.5 μm and
an outermost layer of TiN with a thickness of from about 0.5 to about 1.0 μm,
where the outermost layer of TiN is missing along the cutting edge.

2. A cutting tool insert of claim 1 wherein the outermost layer of TiN has a surface roughness Rₘₐₓ≦0.4 μm over a length of 10 μm at least on the active part of the cutting edge.

3. A cutting tool insert of claim 1 wherein said cemented carbide body comprises from about to 9.5 to about 10.5 wt-% Co, from about 0.38 to about 0.40 wt-% Cr, has a polarization coercivity, HcJ, of from about 19 to about 21 and a CW-value within from about 0.80 to about 0.89.

4. A cutting tool insert of claim 3 wherein said cemented carbide body comprises from about 9.9 to about 10.1 wt-% Co, a polarization coercivity, HcJ, of from about 19.8 to about 20.2 kA/m and a CW-value within from about 0.83 to about 0.87.

5. A cutting tool insert of claim 1 wherein in said first innermost layer y is greater than about 0.8 and z=0.

6. A cutting tool insert of claim 1 wherein in said TiCₓN_{y} layer, x is greater than about 0.5.

7. A cutting tool insert of claim 1 wherein the underlying alumina layer is partly or completely missing along the cutting edge.

8. Method of making a deep hole drilling cutting tool insert comprising a cemented carbide body and a coating wherein said cemented carbide body which comprises WC, from about to 8 to about 11 wt-% Co and from about 0.1 to about 0.5 wt-% Cr with a polarization coercivity, HcJ, of from about 18 to about 22 kA/m and with an CW-value within from about 0.78 to about 0.90, is coated with a coating comprising
a first innermost layer of TiCₓN_{y}O_{z} with x+y+z=1, y>x and z less than about 0.2 with equiaxed grains with a size less than about 0.5 μm and a total thickness of from about 0.1 to about 1.5 μm, using known CVD-methods,
a layer of TiCₓN_{y} with x+y=1, x more than about 0.3 and y more than about 0.3, with a thickness of from about 2 to about 3 μm, with columnar grains and with an average diameter of less than about 5 μm, using MTCVD-technique with acetonitrile as the carbon and nitrogen source for forming the layer in the temperature range of from about 700 to about 900° C.,
a smooth Al₂O₃-layer consisting essentially of κ-Al₂O₃ deposited using known CVD-methods whereby the Al₂O₃ layer has a thickness of from about 1 to about 2.5 μm, and
a further 0.5-1.0 μm thick layer of TiN using known CVD- or PVD-methods, where the TiN-layer is removed along the cutting edge.

9. A method according to claim 8 further comprising gently wetblasting the coating surface with fine grained, from about 400 to about 150 mesh, alumina powder or by brushing the edges to obtain a surface roughness of Rₘₐₓ≦0.4 μm over a length of 10 μm at least on the active part of the cutting edge.

10. A method of claim 9 wherein said cemented carbide body comprises from about to 9.5 to about 10.5 wt-% Co, from about 0.38 to about 0.40 wt-% Cr, has a polarization coercivity, HcJ, of from about 19 to about 21 and a CW-value within from about 0.80 to about 0.89.

11. A method of claim 10 wherein said cemented carbide body comprises from about 9.9 to about 10.1 wt-% Co, a polarization coercivity, HcJ, of from about 19.8 to about 20.2 kA/m and a CW-value within from about 0.83 to about 0.87.

12. A method of claim 9 wherein in said first innermost layer y is greater than about 0.8 and z=0.

13. A method of claim 9 wherein in said TiCₓN_{y} layer, x is greater than about 0.5.

14. A method of claim 9 wherein the underlying aluminium layer is partly or completely missing along the cutting edge.

15. Use of inserts according to claim 1 for deep hole drilling of drive shafts for heat exchangers in steel at a cutting speed of from about 80 to about 160 m/min, feed of from about 0.1 to about 0.3 mm/rev, hole diameter of from about 16 to about 65 mm and a hole length of less than about 1500 mm.
